(19) United States
(12) Patent Application Publication
(10) Pub. No.: US 2011/0262148 A1
(43) Pub. Date: Oct. 27, 2011

(54) COMPACT PLENUM-RATED RIBBON CABLES

(75) Inventor: Peter A. Weimann, Atlanta, GA (US)

(73) Assignee: OFS Fitel, LLC, Norcross, GA (US)

(21) Appl. No.: 12/767,584

(22) Filed: Apr. 26, 2010

(51) Int. Cl. H04B 10/12; G02B 6/44

(52) U.S. Cl. 398/142; 385/114; 385/112

(57) ABSTRACT

Embodiments of the present invention include an optical fiber cable for use in a plenum. The cable comprises a tube, at least one optical fiber ribbon positioned within the tube, the optical fiber ribbon having a width (W), a jacket around the tube, the jacket having an outer diameter (D) and a limited oxygen index (LOI) of approximately at least 65%, at least two longitudinal strength members positioned between the tube and an outer surface of the jacket; and a yarn positioned between the tube and the jacket, wherein the ratio of the width (W) of the optical fiber ribbon and the outer diameter (D) of the jacket is approximately at least 0.25.

### TECHNICAL FIELD

The invention relates to plenum optical fiber cables. More particularly, the invention relates to plenum optical fiber cables having stacked optical fiber ribbons therein, and systems using such cables.

### BACKGROUND OF THE INVENTION

Optical cables typically comprise one or more multi-fiber units such as in a multi-fiber unit tube. Inside of a multi-fiber unit tube typically includes a plurality of individual optical fiber. In one configuration, the optical fibers are arranged loosely within the multi-fiber unit tube. However, such arrangement has relatively low fiber packing densities, and many applications prefer optical fiber cables with higher fiber packing densities.

In another optical fiber cable configuration, the optical fibers are bound together as one or more planar optical fiber ribbons in a multi-fiber unit tube. The optical fiber ribbons typically are stacked within the multi-fiber unit tube (See for example U.S. Pat. No. 6,778,745).

Optical fiber ribbons are commonly used for outside plant applications in North America because of the high fiber packing density and ease of mass-fusion splicing. Water is one of the problems in outside plant applications. To address the issue, many conventional optical fiber ribbon stack arrangements include various kinds of filler materials, such as hydrophobic (water blocking) and hydrophilic (water absorbing) gels, powders, yarns and tapes.

Such optical fiber ribbons are also used in some indoor cable applications; however, their use has been limited mainly due to two reasons: 1) the difficulty in meeting stringent fire standards, and 2) the difficulty in terminating optical fiber ribbon cables with connectors in the indoor environment.

Cables used in the indoor applications may be categorized as plenum cables, riser cables, or general purpose cables. The plenum category requires the most stringent standards for flame propagation and optical smoke density properties. If a cable is approved for plenum use, it will automatically meet the flame propagation and optical smoke density requirements for riser cable and general purpose cable uses.

The plenum is the space that can facilitate air circulation for heating and air conditioning systems, by providing pathways for either heated/conditioned or return airflows, generally over a drop ceiling or under a raised floor. The plenum space is often used for housing the communication cables for the building's computer and telephone network in data centers, supercomputing facilities, storage-area networks and other enterprise networks. Such plenum space may pose a serious hazard in the event of a fire, as once the fire reaches the plenum space the airflow present in the space supplies fresh oxygen to the flame and makes it grow much stronger than it would have otherwise been. In the United States, all optical cables to be placed in plenum spaces must be designed to meet rigorous fire safety test standards in accordance with National Fire Protection Association (NFPA) 262.

NFPA 262 is the generally accepted standard for plenum cables in North America. The standard states values for the maximum flame-propagation distance and peak and average optical density for plenum use. Any cables, which are acceptable under NFPA 262 will be referred as plenum cables.

NFPA 262 is a fire test for determining values of flame-propagation distance and optical smoke density for electrical and optical-fiber cables not enclosed in raceways that are to be installed in plenums used to transport environmental air. To be judged acceptable under NFPA 262, a cable must exhibit each of the following criteria when exposed to flame under certain conditions in a horizontal testing chamber: (a) the maximum flame-propagation distance is not to be greater than 5 ft beyond the initial 4.5 ft test flame; (b) the peak optical density of the smoke produced is to be 0.50 or less (32% light transmission); and (c) the average optical density of the smoke produced is to be 0.15 or less. One type of plenum optical fiber cable with optical fiber ribbons are disclosed in U.S. Pat. No. 5,748,823.

Plenum cables containing optical ribbons that are currently available in the market are relatively large and bulky. If those bulky cables are used in a data center, where the plenum space is used to deliver cooling air to active equipment, those cables restrict airflow within the data center and limit the cooling efficiency of the data center. In addition, due to their weight and size, bulky cables are more difficult to route and install in constrained plenum spaces.

Recently developed high-density array connectors for optical ribbons—such as the US Conec MTP® or MPO type connectors manufactured by the Furukawa Electric Co., LTD.—are easy to use and have a much higher connection density that single fiber connectors. These connectors make it easy to terminate optical fiber ribbon cables in the indoor environment. However; there is sill a need for small plenum optical fiber cables, which have high optical fiber packing density and satisfy NFPA 262 plenum fire standard.

### BRIEF SUMMARY OF THE INVENTION

Therefore, an object of the present invention is to provide small plenum optical fiber cables, which have high optical fiber packing density and satisfy NFPA 262 plenum fire standard.

According to one embodiment of the present invention, this and other objects are provided by an optical fiber cable for use in a plenum, the cable comprising, An optical fiber cable for use in a plenum, the cable comprising a tube, at least one optical fiber ribbon positioned within the tube, the optical fiber ribbon having a width (W), a jacket around the tube, the jacket having an outer diameter (D) and a limited oxygen index (LOI) of approximately at least 65%, at least two longitudinal strength members positioned between the tube and an outer surface of the jacket; and a yarn positioned between the tube and the jacket, wherein the ratio of the width (W) of the optical fiber ribbon and the outer diameter (D) of the jacket is approximately at least 0.25.

According to another embodiment of the invention, an optical fiber system for transmitting optical signal in plenum applications is disclosed. The system comprises at least one optical source, an optical fiber cable coupled to the source for transmitting optical signal from the source, and a receiver coupled to the optical fiber cable for receiving the transmitted optical signal, wherein the optical fiber cable comprises a tube, at least one optical fiber ribbon positioned within the tube, the optical fiber ribbon having a width (W), a jacket around the tube, the jacket having an outer diameter (D) and a limited oxygen index (LOI) of approximately at least 65%, at least two longitudinal strength members positioned between the tube and an outer surface of the jacket; and a yarn positioned between the tube and the jacket, wherein the ratio of the width (W) of the optical fiber ribbon and the outer diameter (D) of the jacket is approximately at least 0.25.

### BRIEF DESCRIPTION OF THE DRAWINGS

Reference will now be made to the accompanying figures and flow diagrams, which are not necessarily drawn to scale, and wherein:

FIG. 1 is a perspective view of an optical fiber cable according to an embodiment of the invention;

FIG. 2. is a cross-sectional view of the cable of FIG. 1; and

FIGS. 3a-3f are cross-sectional view of optical fiber cables according to alternative embodiments of the invention; and

FIG. 4 is a simplified schematic diagram of an optical system, which the cable of FIG. 1 can be used.

### DETAILED DESCRIPTION

In the following description, similar components are referred to by the same reference numeral to enhance the understanding of the invention through the description of the drawings. Also, unless otherwise explicitly specified herein, the drawings are not drawn to scale.

Although specific features, configurations and arrangements are discussed herein below, it should be understood that such is done for illustrative purposes only. A person skilled in the relevant art will recognize that other steps, configurations and arrangements are useful without departing from the spirit and scope of the invention.

Optical Fiber Nonconductive Plenum (OFNP) cables with optical fiber ribbons are available in the market; however, those cables are large and bulky. For example Prysmian offers 24 to 144 fibers in a cable with an outer diameter of 14.7 mm. The problem is that such large cables are undesirable for plenum space such as in data center environments. The large size of the cables can restrict air flow, which is critical to cool plenum spaces in environments such as data centers and supercomputing facilities that consume large amounts of power and generate a relatively large amount of heat. In addition, the large size of the cables makes it difficult to route them in troughs and shelves. To route such bulky cables in troughs and shelves, a special furcation is required to transit the bulky cable from overhead racks down through the troughs into the shelves and faceplates for termination.

Several center tube optical fiber ribbon cables are made with different combinations of core tube and jacket materials. Each cable is evaluated according to the criteria of NFPA 262 to find the optimal combination of tube and jacket materials for small plenum optical fiber cables. Materials selected for testing included SOLEF® 32008/0009, a flame-retardant polyvinylidene fluoride (PVDF) copolymer compound manufactured by Solvay Solexis, having a Limiting Oxygen Index (LOI) of 100%; SOLEF® 31508/0009, a PVDF copolymer compound manufactured by Solvay Solexis, having a LOI of 100%; Fireguard® 910 FOB L16 OA, a flame-retardant polyvinyl chloride (PVC) compound, manufactured by Teknor Apex, having a LOI of 52%; and SmokeGuard IV Natural 1320, a PVC compound, manufactured by AlphaGary, having a LOI of 57%. Test results are set out in Table 1 below. In order to be considered as passing, two different samples must meet all of the following criteria: flame spread of shorter than 5 feet; peak optical density of less than 0.50; and average optical density of less than 0.15.

TABLE 1

| | | | | Flame | | | |
|---|---|---|---|---|---|---|---|
| Sample | Fiber | | | Spread, | | Avg | Test |
| # | Count | Tube Construction | Jacket Construction | Feet | Peak OD | OD | result |
| 1 | 72 | 6.1 mm OD, 0.5 mm | 9.4 mm OD, Teknor | 6 | 1.05 | 0.3 | Fail |
| | | thick, SOLEF | Apex 910 FOB L16 | | | | |
| | | 32008/0009 PVDF | C1A PVC jacket | | | | |
| 2 | 24 | 6.1 mm OD, 0.5 mm | 9.4 mm OD, | 1 | 0.27 | 0.16 | Fail |
| | | thick, SOLEF | AlphaGary SGIV | | | | |
| | | 32008/0009 PVDF | 1320 PVC jacket | | | | |
| 3 | 24 | 6.1 mm OD, 0.5 mm | 9.4 mm OD, | 1 | 0.28 | 0.16 | Fail |
| | | thick, SOLEF | AlphaGary SGIV | | | | |
| | | 32008/0009 PVDF | 1320 PVC jacket | | | | |
| 4 | 96 | 6.8 mm OD, 0.5 mm | 10.2 mm OD, | 1.5 | 0.33 | 0.19 | Fail |
| | | thick, SOLEF | AlphaGary SGIV | | | | |
| | | 32008/0009 PVDF | 1320 PVC jacket | | | | |
| 5 | 12 | 6.1 mm OD, 0.5 mm | 9.4 mm OD, | 1.5 | 0.27 | 0.15 | Fail |
| | | thick, SOLEF | AlphaGary SGIV | | | | |
| | | 32008/0009 PVDF | 1320 PVC jacket | | | | |
| 6 | 12 | 6.1 mm OD, 0.5 mm | 9.4 mm OD, | 1.5 | 0.33 | 0.17 | Fail |
| | | thick, SOLEF | AlphaGary SGIV | | | | |
| | | 32008/0009 PVDF | 1320 PVC jacket | | | | |
| 7 | 72 | 6.1 mm OD, 0.5 mm | 9.4 mm OD, | 3 | 0.35 | 0.2 | Fail |
| | | thick, SOLEF | AlphaGary SGIV | | | | |
| | | 32008/0009 PVDF | 1320 PVC jacket | | | | |
| 8 | 24 | 6.1mm OD, 0.5 mm | 9.8 mm OD, | 2.5 | 0.33 | 0.18 | Fail |
| | | thick, SOLEF | AlphaGary SGIV | | | | |
| | | 32008/0009 PVDF | 1320 PVC jacket, | | | | |
| | | | jacketed to 1.0 mm | | | | |
| | | | with 32008/0009 | | | | |
| | | | PVDF | | | | |
| 9 | 72 | 6.1 mm OD, 0.5 mm | 9.8 mm OD, | 3 | 0.34 | 0.19 | Fail |
| | | thick, SOLEF | AlphaGary SGIV | | | | |
| | | 32008/0009 PVDF | 1320 PVC jacket, | | | | |
| | | | jacketed to 1.0 mm | | | | |
| | | | with 32008/0009 | | | | |
| | | | PVDF | | | | |
| 10 | 12 | 6.1 mm OD, 0.5 mm | 9.4 mm OD, | 1 | 0.4 | 0.23 | Fail |
| | | thick, SOLEF | AlphaGary SGIV | | | | |
| | | 32008/0009 PVDF | 1320 PVC jacket, | | | | |
| | | | alternate extrusion | | | | |
| | | | method | | | | |
| 11 | 72 | 6.1 mm OD, 0.5 mm | 9.4 mm OD, | 2 | 0.48 | 0.27 | Fail |
| | | thick, SOLEF | AlphaGary SGIV | | | | |
| | | 32008/0009 PVDF | 1320 PVC jacket, | | | | |
| | | | alternate extrusion | | | | |
| | | | method | | | | |
| 12 | 72 | 6.1 mm OD, 0.5 mm | 8.7 mm OD, SOLEF | 1 | 0.11 | 0.06 | Pass |
| | | thick, SOLEF | 31508/0009 PVDF | | | | |
| | | 32008/0009 PVDF | | | | | |

To simplify the comparison between samples, the same PVDF compound (SOLEF® 32008/0009) is used for all sample tubes. However, it will be appreciated that the tube construction is not limited to this specific PVDF compound and other compounds including fluoropolymers such as PFA or ECTFE; fluoropolymer/PVC blends; or high-LOI low-smoke PVC compounds could be used as a tube material. Preferably, a compound with LOI of 65% or more should be used for the tube, and the tube is made from PVDF compound. PVDF compounds are preferred as they can be processed at relatively low temperatures (e.g. less than 500 F), and such PVDF compounds may be processed without any special high-temperature extrusion equipments.

The results show that jacket compound needs to have relatively high LOI to pass the test. More specifically, compound with LOI of 65% or more should be used for the jacket. Preferably, the compound with LOI of 80% or more should be used for the jacket. Most preferably, the compound with LOI of 95% or more should be used for the jacket. Preferably, the jacket is made from PVDF compound.

Next, kink resistance test have been performed to test the mechanical robustness of the cables. Kink means a bending to a radius where discontinuous deformation of a cross-section of cable jacket and/or one or more of strength members (if any) occurs. If kinks are occurred, an optical fiber cable is plastically deformed and may not return to its original shape. Kinks may result in mechanical damage to the delicate optical fibers and/orhighly degraded optical performance (e.g. large signal loss).

To prevent such kinks, strength members such as rigid rods may be inserted within the cable. In the following test, cables with and without rods are tested. Each cable tested had 24 fibers (i.e. two 12 fiber ribbons), and all of the sample cables have the identical core tube dimensions. Diameters of the sample cables with rods are slightly larger than ones without rods to cover rods fully.

To measure kink resistance of each sample, each sample cable is secured with a clamp, and bent over a sharp edge by hand to make the cable flatten at a bending point; then an aluminum wedge clamp is applied at one end of the cable and the width of the cable is measured at the bending point. Next, a 1.5 kg weight is applied to the cable through the aluminum wedge clamp to create a tensile load, and then change in the width due to the load is measured. If a kink occurs, the cable will flatten severely at the sharp angle, increasing its width by 20% or more. If the cable does not kink, it will maintain a relatively round shape and not exhibit flattening. Test results are set out in Table 2 below.

TABLE 2

| | Width with | Width with 1.5 | | |
|---|---|---|---|---|
| | no added load | kg added load | | |
| Sample | on sharp | on sharp | Change in | Change in |
| Cable | edge, mm | edge, mm | width, mm | width, % |
| No rods #1 | 8.83 | 10.85 | 2.02 | 23% |
| No rods #2 | 8.33 | 10.71 | 2.38 | 29% |
| No rods #3 | 8.69 | 11.04 | 2.35 | 27% |
| No rods #4 | 8.55 | 11.23 | 2.68 | 31% |
| No rods #5 | 8.47 | 10.75 | 2.28 | 27% |
| With rods #1 | 9.17 | 10.04 | 0.87 | 9% |
| With rods #2 | 9.3 | 9.53 | 0.23 | 2% |
| With rods #3 | 9.24 | 9.94 | 0.7 | 8% |
| With rods #4 | 9.56 | 10.01 | 0.45 | 5% |
| With rods #5 | 9.4 | 9.96 | 0.56 | 6% |

The test results above show that cables without rods experience relatively large change in their widths (23%˜31%); however, cables with rods experience relatively small change in their widths (2%˜9%). Because plenum is the space that can facilitate air circulation for heating and air conditioning systems, by providing pathways for either heated/conditioned or return airflows, generally over a drop ceiling or under a raised floor, the plenum cables are subject to sharp bends and may experience relatively large tensile loads during the installation and/or duration of its service. Therefore, cables with rods (i.e. strength members) are preferred for plenum cables to prevent damage or highly degraded optical performance of the fibers inside the cable from kinks.

Based on the NFPA 262 and kink resistance tests above, small plenum optical fiber cables with high optical fiber packing density are constructed.

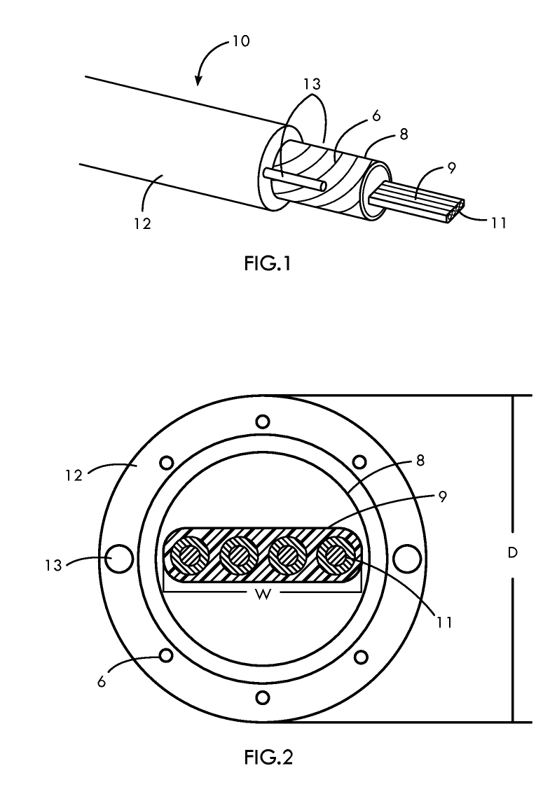

FIG. 1 shows an optical fiber cable 10 according to one embodiment of the invention. A tube 8 encloses an optical fiber ribbon 9. In this embodiment, only one optical fiber ribbon 9 with four optical fibers 11 are shown. However, multiple optical fiber ribbons can be stacked on top of each other. The number of optical fiber ribbons and number of optical fibers within the optical fiber ribbons can vary; the actual configuration chose it depends on factors such as the dimensions of the fiber ribbons, the dimensions of the tube and application of the cable. For example, optical fiber ribbons can be arranged as follows: a 12-fiber stack formed by a 3×4 array of optical fibers (i.e., 3 ribbons having 4 fibers per ribbon) or a 144-fiber stack formed by a 12×12 array optical fibers (i.e., 12 ribbons having 12 fibers per ribbon).

The tube 8 is made from a compound with LOI of 65% or more. One example of a suitable material is SOLEF 32008/0009, flame-retardant PVDF material. This PVDF material has a LOI of 100%.

Furthermore, the cable 10 includes a protective jacket 12 formed around the tube 8. The jacket 12 is made from a compound with LOI of 65% or more. Preferably, the jacket 12 has a LOI of greater than 95. One example of a suitable material with LOI of 95 or more is SOLEF 31508/0009, a flame-retardant PVDF copolymer material. This PVDF material has a LOI of 100%. In addition, at least one ripcord (not shown) may be partially embedded in the jacket 12 to make it easy for on-site technicians to remove jacket 12 if needed.

The cable 10 also includes two or more rigid strength members 13 and flexible strength yarn 14 between the tube 8 and the jacket 12. For example the yarn 14 and the strength members 13 are covered by the jacket material when the jacket 12 is pressure extruded around the tube 8. This affords improved anti-buckling characteristics and excellent low temperature performance by locking the rigid strength members 13 and the yarn 14 in place.

The rigid strength members 13 can be made from any suitable material and can be in any suitable shape. The strength members provide crush and kink resistance and keep the cable from having “memory”. The two longitudinal strength members 13 in the cable 10 are preferably positioned symmetrically with respect to the center of the cable for better absorption of any bending, compression, or extension applied during an installation or in life of an operation. Furthermore, steel, glass-epoxy composite rod, and aramid-epoxy composite rod, and other composites are commonly used as material for the strength members 13. However, the strength members 13 are preferred to be made from dielectric materials, such that they will not generate induced current within the strength members 13 when there are electric currents nearby the cable 10. This also avoids the cost and expense of electrically grounding the optical cable. For example, 0.7 mm diameter, round E-glass/epoxy rods, such as those manufactured by CrWW & Associates, Hope Valley, R.I. may be employed as suitable strength members. Also, the strength members are preferably applied linearly, without any twisting or change in location relative to the cable core tube. The linearly-applied strength members 13 make the bending performance of cable 10 elastic (if the cable 10 is bent, and then the bending deformation is relieved and the cable snaps back into place). This behavior limits kinking of the cable 13 in tight bends, which could impair the optical signal and/or damage the optical fibers 11. The strength members 13 also limit the bend radius of the cable 10 by preventing the installer from coiling the cable 13 too tightly. The strength members 13 are approximately 20 weight % flammable epoxy and 80 weight % inflammable glass, and their presence or absence does not actually affect fire performance shown in Table 1.

A strength yarn 14 is placed in the cable 10 between the tube 8 and the jacket 10. With strength members 13, the yarn 14 provides resistance to the tensile loads applied during installation; however, the flexibility of the yarn prevents the cable from being too stiff and too hard to bend. E-glass yarn, aramid yarn, or other suitable material can be used as a material for the strength yarn 14. In preferred embodiments, an aramid yarn such as Kevlar® 49, manufactured by E.I. DuPont deNemours & Co, is used; and the yarn is helically twisted while being placed between the tube 8 and the jacket 12.

Strength members 13 are used so that the tube 8 does not excessively flatten and/or kink during bending or compression throughout the cable's temperature service window, while keeping the plenum optical fiber cable 10 relatively small. Flattening or kinking of a core tube can impart severe stresses to the fiber ribbons (or optical fibers within the ribbon) within the tube and possibly cause signal attenuation and/or mechanical damage to the fragile glass optical fibers. Therefore, long term reliability of the cable can be degraded. However, combination of the two strength members 13 and the yarn 14 prevents (or reduces) such bending and, at the same time, reduces overall cable size.

The optical fiber ribbon 9 has a width (W) and the jacket 12 has an outer diameter (D). Conventionally, the W/D ratio of typical plenum-rated center tube optical fiber ribbon cable is approximately 0.15 to 0.21. However, according to an embodiment of the invention, the W/D ratio is at least 0.25 or, preferably, at least 0.30. Novel selection of materials for the jacket, and combination of two strength members and yarn create the relatively large W/D ratio for the cable relates to the present invention.

For example, for a typical 12×12 array plenum center tube optical fiber ribbon cable, the width (W) of the stacked fiber ribbon is approximately 3.06 mm and the diameter (D) of the outer jacket is approximately 14.7 mm. However, for a 12×12 array plenum center tube optical fiber ribbon cable according to an embodiment of the invention, the width (W) of the stacked fiber ribbon is approximately 3.07 mm and the diameter (D) of the outer jacket is approximately 11.2 mm.

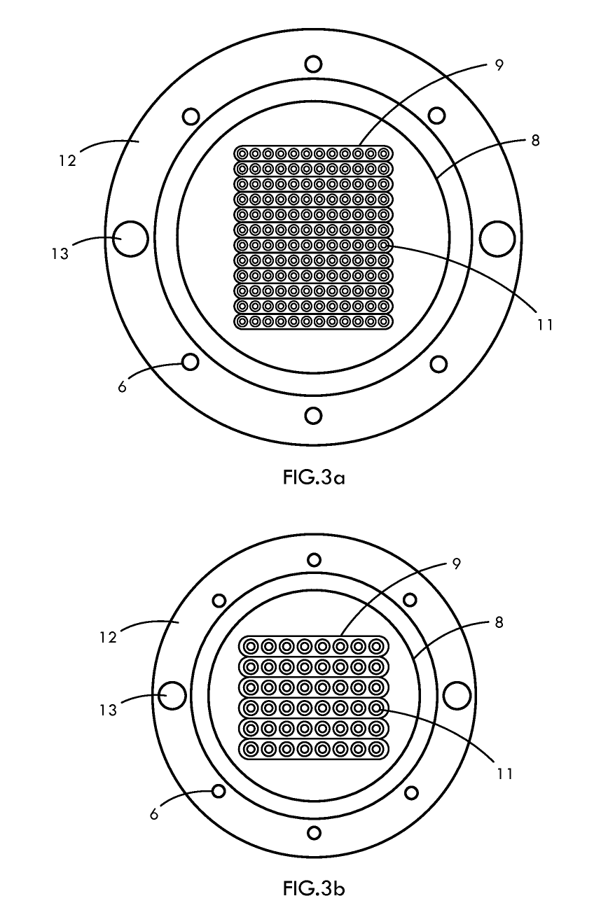

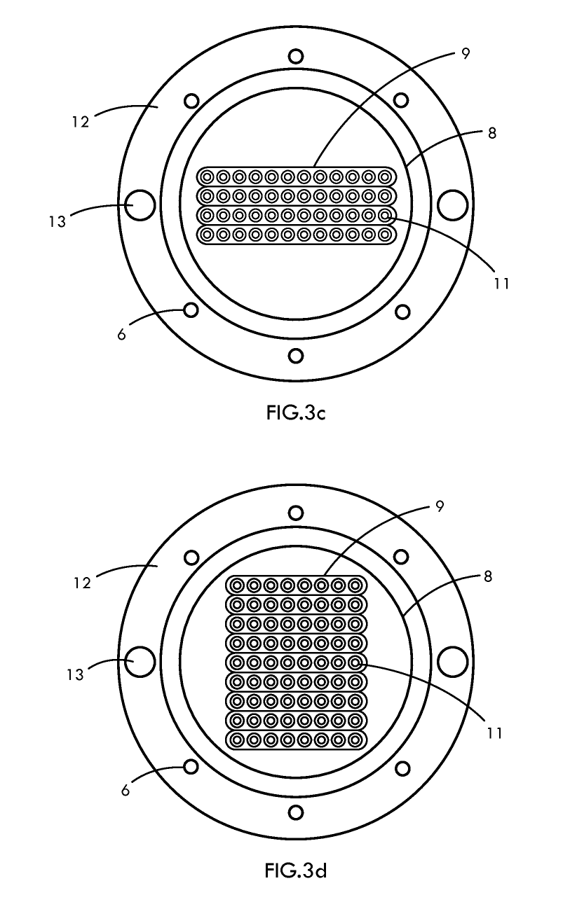

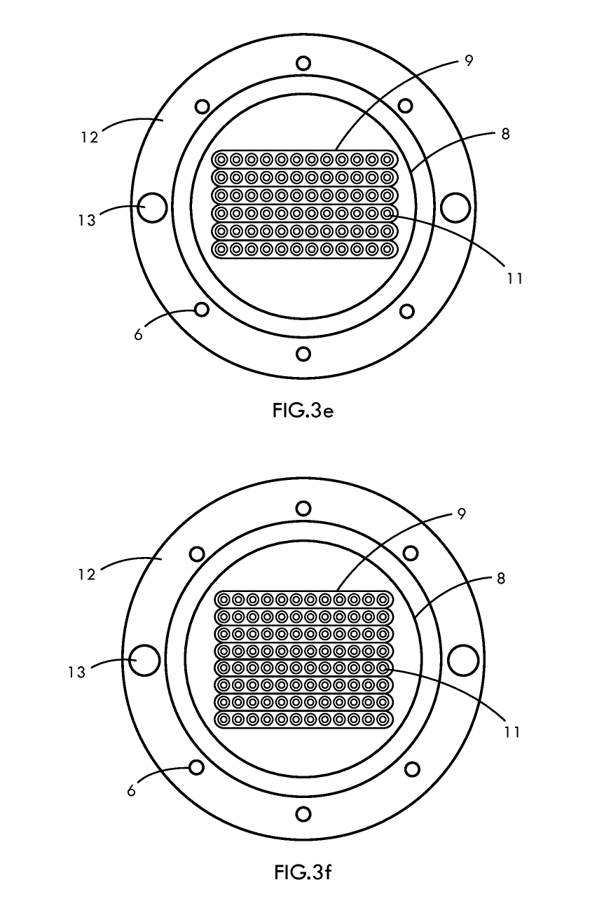

As mentioned previously herein, according to embodiments of the invention, ribbon stack arrangements other than the 1×4 array shown in FIG. 1 are suitable for positioning in the tube 8. For example, the various fiber array arrangements are shown in FIGS. 3 a-f. For example, FIG. 3 a shows a 144-fiber (12×12) arrangement positioned in a tube 8. FIGS. 3 b and 3 c show various 48-fiber arrangements: a 6×8 ribbon stack array (e.g., 6 ribbons having 8 fibers per ribbon) in FIG. 3 b, and a 4×12 ribbon stack array (e.g., 4 ribbons having 12 fibers per ribbon) in FIG. 3 c. FIGS. 3 d-e show various 72-fiber arrangements: a 9×8 ribbon stack array (e.g., 9 ribbons having 8 fibers per ribbon) in FIG. 3 d and a 6×12 ribbon stack array (e.g., 6 ribbons having 8 fibers per ribbon) in FIG. 3 e. In FIG. 3 f, a 96-fiber arrangement (8 ribbons having 12 fibers per ribbon) is shown.

Comparison among examples (embodiments of the inventive plenum cable) and comparative examples (other plenum cables in the market) is shown in Table 3.

TABLE 3

| | Fiber | # of | Stack | Cable | |
|---|---|---|---|---|---|
| Sample | Counts | units | Width, mm | diameter, mm | W/D |
| Example 1 | 24 | 2 | 3.06 | 8.7 | 0.35 |
| Example 2 | 48 | 4 | 3.06 | 8.7 | 0.35 |
| Example 3 | 72 | 6 | 3.06 | 8.7 | 0.35 |
| Example 4 | 96 | 8 | 3.06 | 9.4 | 0.33 |
| Example 5 | 144 | 12 | 3.06 | 11.1 | 0.28 |
| comparative | 24 | 2 | 3.06 | 14.7 | 0.21 |
| example 1 | | | | | |
| comparative | 48 | 4 | 3.06 | 14.7 | 0.21 |
| example 2 | | | | | |
| comparative | 72 | 6 | 3.06 | 14.7 | 0.21 |
| example 3 | | | | | |
| comparative | 96 | 8 | 3.06 | 14.7 | 0.21 |
| example 4 | | | | | |
| comparative | 144 | 12 | 3.06 | 14.7 | 0.21 |
| example 5 | | | | | |
| comparative | 16 | 2 | 2.04 | 8.7 | 0.23 |
| example 6 | | | | | |
| comparative | 32 | 4 | 2.04 | 8.7 | 0.23 |
| example 7 | | | | | |
| comparative | 64 | 6 | 2.04 | 8.7 | 0.23 |
| example 8 | | | | | |
| comparative | 72 | 8 | 2.04 | 9.4 | 0.22 |
| example 9 | | | | | |
| comparative | 96 | 12 | 2.04 | 9.4 | 0.22 |
| example 10 | | | | | |

As is shown in Table 3, examples 1˜5 have higher W/D ratio than any of the comparative examples. This means that any examples 1˜5 can contain more fibers with the same diameter; or for the same number of fibers, the cable can be made smaller.

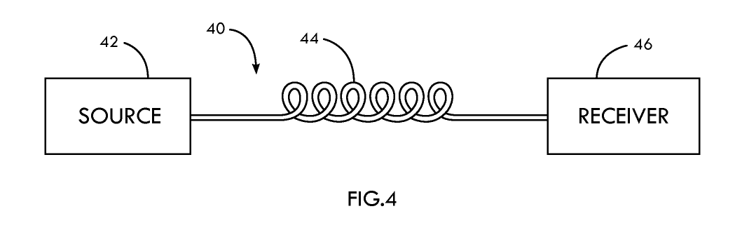

Optical fiber cables according to embodiments of the invention are suitable for use in various optical communication systems. Referring now to FIG. 4, shown is a simplified block diagram of an optical communication system 40 according to embodiments of the invention is shown. The system 40 includes one or more sources 42 for transmitting optical information, an optical transmission medium 44 such as one or more optical cables configured according to embodiments of the invention, and one or more receivers 46 for receiving the transmitted information. The source 42, which is configured to transmit optical information, is coupled to the optical transmission medium 44, e.g., in a conventional manner. The receiver 46, which is configured to receive the transmitted optical information, is coupled to the optical transmission medium 64, e.g., in a conventional manner.

It will be apparent to those skilled in the art that many changes and substitutions can be made to the embodiments of the optical fiber cables herein described without departing from the spirit and scope of the invention as defined by the appended claims and their full scope of equivalents.

What is claimed is:

1. An optical fiber cable for use in a plenum, the cable comprising:
a tube;
at least one optical fiber ribbon positioned within the tube, the optical fiber ribbon having a width (W);
a jacket around the tube, the jacket having an outer diameter (D) and a limited oxygen index (LOI) of approximately at least 65%;
at least two longitudinal strength members positioned between the tube and an outer surface of the jacket; and
a yarn positioned between the tube and the jacket, wherein the ratio of the width (W) of the optical fiber ribbon and the outer diameter (D) of the jacket is approximately at least 0.25.

2. The optical fiber cable in claim 1, wherein the cable has plurality of optical fiber ribbons within the tube, and the plurality of optical fiber ribbons stack on top of each other.

3. The optical fiber cable in claim 2, wherein the stacked plurality of optical fiber ribbons further comprises any optical fiber array combination between a 2×4 array and a 12×12 array.

4. The optical fiber cable in claim 3, wherein the stacked plurality of optical fiber ribbons further comprises any 12-fiber ribbon array between a 2×12 array and the 12×12 array, any 8-fiber ribbon array between a 2×8 array and a 12×8 array, a 3×4 array or the 2×4 array.

5. The optical fiber cable in claim 1, wherein the jacket has a LOI of at least 80%.

6. The optical fiber cable in claim 5, wherein the jacket has a LOI of at least 95%.

7. The optical fiber cable in claim 1, wherein the jacket is made from fluoropolymer.

8. The optical fiber cable in claim 7, wherein the fluoropolymer is polyvinylidene fluoride (PVDF) copolymer.

9. The optical fiber cable in claim 1, wherein the two strength members are rigid rods positioned symmetric with respect to the center of the cable.

10. The optical fiber cable in claim 1, wherein the strength members are made from dielectric material.

11. The optical fiber cable in claim 1, wherein the yarn positioned helically between the tube and the jacket.

12. The optical fiber cable in claim 1, wherein the yarn is an aramid yarn.

13. The optical fiber cable in claim 1, wherein the ratio of the width (W) and the outer diameter (D) is at least 0.30.

14. The optical fiber cable in claim 1, wherein the tube has a LOI of approximately at least 65%.

15. An optical fiber system for transmitting optical signal in plenum applications, the system comprising;
at least one optical source;
an optical fiber cable coupled to the source for transmitting optical signal from the source; and
a receiver coupled to the optical fiber cable for receiving the transmitted optical signal,
wherein the optical fiber cable comprises
a tube;
at least one optical fiber ribbon positioned within the tube, the optical fiber ribbon having a width (W);
a jacket around the tube, the jacket having an outer diameter (D) and a limited oxygen index (LOI) of approximately at least 65%;
at least two longitudinal strength members positioned between the tube and an outer surface of the jacket; and
a yarn positioned between the tube and the jacket, wherein the ratio of the width (W) of the optical fiber ribbon and the outer diameter (D) of the jacket is approximately at least 0.25.

16. The optical fiber system in claim 15, wherein the cable has plurality of optical fiber ribbons within the tube, and the plurality of optical fiber ribbons stack on top of each other.

17. The optical fiber system in claim 15, wherein the jacket has a LOI of at least 95%.

18. The optical fiber system in claim 15, wherein the jacket is made from fluoropolymer.

19. The optical fiber system in claim 15, wherein the two strength members are rigid rods positioned symmetric with respect to the center of the cable.

20. The optical fiber system in claim 15, wherein the ratio of the width (W) and the outer diameter (D) is at least 0.30.
